(19) United States
(12) Patent Application Publication
(10) Pub. No.: US 2025/0120390 A1
(43) Pub. Date: Apr. 17, 2025

(54) METHODS TO PRESERVE PLANT PIGMENTS AND ENHANCE SEED GERMINATION USING OXYGEN SCAVENGING AGENTS

(71) Applicant: Sensient Colors, LLC, St. Louis, MO (US)

(72) Inventors: Vergel CONCIBIDO, Maryland Heights, MO (US); Bradley LA VALLEE, Chesterfield, MO (US); Jöerg MEYER, St. Charles, MO (US); Lourdes GREFAL, Binan (PH); Rommel CALMA, Binan (PH); Marie Leila HERNANDEZ, Santa Rosa (PH)

(21) Appl. No.: 18/632,777

(22) Filed: Apr. 11, 2024

Related U.S. Application Data
(63) Continuation of application No. 17/403,238, filed on Aug. 16, 2021, now abandoned.
(60) Provisional application No. 63/065,579, filed on Aug. 14, 2020.

(51) Int. Cl. A01N 3/00

(52) U.S. Cl. CPC A01N 3/00

(57) ABSTRACT

The disclosure provides for compositions and methods for the preservation of plant parts, including leaves and seeds. In particular, the compositions and methods reduce light-induced discoloration.

### CROSS-REFERENCE TO RELATED APPLICATIONS

This application is a continuation of U.S. application Ser. No. 17/403,238, filed Aug. 16, 2021, which application claims the benefit of U.S. Provisional Application 62/486,776, filed Apr. 18, 2017, which applications are incorporated herein by reference in their entireties.

### BACKGROUND

The present disclosure provides a method of preserving plant pigments i.e., preventing discoloration of a plant part, and enhancing seed germination of a plant part comprising placing a plant part in container having a low oxygen environment, wherein the low oxygen environment comprises at least one oxygen-scavenging agent.

In one embodiment, the low oxygen environment may contribute to increased germination of a plant part i.e., a seed, wherein the low oxygen environment comprises at least one oxygen-scavenging agent.

In another embodiment, the low oxygen environment may further comprise a nitric oxide, wherein the nitric oxide is stably maintained in deoxygenated water. The water containing the nitric oxide may be segregated from the one or more oxygen-scavenging agent, such as in an air-permeable sachet or packet.

In yet another embodiment, the low oxygen environment may be a nitrogen gas-flushed environment. The container may be formed by a rigid or flexible polymer packaging material. The oxygen-scavenging agent may be located in an air-permeable sachet located in the container or boated in the rigid or flexible polymer packaging material or a film applied thereto. The plant part may be a leaf, flower, or seed. The plant part may chosen from a plant selected from the group consisting of a butterfly pea, safflower, hibiscus, and annatto.

### DETAILED DESCRIPTION

### A. Oxygen Scavenging Agents

Oxygen scavengers include both enzymatic and non-enzymatic agents. Oxygen scavenger agents must satisfy certain requirements in order to be used for preserving plant pigments i.e., preventing discoloration of a plant part, and enhancing seed germination of a plant part. The oxygen scavenging agent must be harmless to the human body, absorb oxygen at an appropriate rate, not produce toxic substances or unfavorable gas or odor, be compact in size, show a constant quality and performance, absorb a large amount of oxygen, be economically priced, and not discolor a plant part if the scavenger packet comes in contact with the plant part.

### B. Seed Storage

The purpose of seed storage is to maintain seed in good physical and physiological condition from harvesting through planting by the farmer. For most crops, time passes between harvesting and planting and the seed has to be kept somewhere during this period and storage is necessary. For some crops, seed can be sown almost immediately after harvesting with little or no requirement for storage. For example, in some countries, the seed of a particular crop may be harvested and then almost planted immediately.

In lowland areas, or for a crop such as rice, harvested crop may be produced two or three times a year, reducing the seed storage period. Traditionally, the primary purpose of storing seeds at the farm level is to preserve seed stocks for sowing or planting in the following season. However, extended storage i.e., keeping seed for ≥2 years to meet future demand, may be necessary for various reasons:

Therefore, there is a need to preserve material of well-adapted and preferred varieties, especially at the level of farmers in local communities.

There is a perceived risk of crop failure in difficult conditions. Part of the production from a good harvest is kept as buffer stock to cover seed needs in less productive years. Seed yield and quality, particularly germination and vigor, can be unpredictable due to growing conditions.

There are variations in market demand for certain crops and seeds. When seed suppliers do not manage to market all their seed during the immediate planting season, the unsold seed is carried over to the second planting season. However, not all seeds naturally store well for carryover purposes; for example, groundnut, soybean, and onion seeds have a naturally short storage life.

Farmers may eliminate the need to produce seeds every season. This is a potentially efficient and economical strategy for foundation seed enterprises producing seed of varieties with limited demand during any given season. In fact, many kinds of seed lots, mostly vegetable, flower and forage seeds, in international trade, are not used the first year after production.

There is a provision of sufficient time for breaking dormancy, thus improving the percentage of germination.

Conservation of genetic resources, which requires long-term seed storage.

Regardless of the specific reasons for storage of seed, the purpose remains the same, to maintain a satisfactory capacity of the seed for germination and field emergence. The facilities used and procedures adopted in storage must focus on this purpose. During storage, seed must be regularly tested, particularly for germination capacity.

Seed is routinely stored for >1 year, and is it is important to understand how operations during the different segments of storage e.g, harvesting, drying and threshing, processing, storage, and transportation, affect the longevity and vigor of the seed. Seeds are fragile living organisms, and their shelf-life is affected from the beginning of the plant life cycle by soil nutrition, plant health and other factors. Provision of optimum conditions for crop growth and health is fundamental; nevertheless, the greatest impact on seed viability and vigor is made by harvesting, threshing/extraction, drying, cleaning, transportation and storage. Care must be taken to minimize seed damage and maximize seed viability and vigor from pre-harvest through to post-harvest handling.

### C. Types of Seed Storage Requirements

In general, the cost of storage facility per unit of seed stored increases in line with storage requirements. The type of storage required depends mainly on the expected duration of storage, classified into five categories:
1. Short-term storage of farm-saved seed or community seed banks.
2. Short-term storage of early-generation seed stocks (breeder and foundation seed).
3. Short-term storage of commercial seed stocks (certified seed).
4. Storage of carryover seeds (both early-generation and commercial seed).
5. Long-term storage of germplasm seeds (genetic resources).

### D. Sensitivity of Seeds to Drying and Temperature

Seeds differ in terms of sensitivity to drying and temperature; some seeds lose their viability once they reach a certain level of moisture content. Seed moisture is a critical factor determining the viability and longevity of all seed types. For this reason, it is fundamental to identify the seed type before considering the method of storage. In terms of seed longevity and the effects of drying and storage on germination, there are different seed categories:
1. Orthodox seeds—long-lived, can be dried to moisture content of 5% (i.e. lower than they would normally achieve in nature) without damage, can be packaged and tolerate freezing. The longevity of orthodox seeds increases with reduction in both moisture content and temperature in a wide range of storage environments. Ex situ conservation of orthodox seeds is, therefore, not problematic. Examples of orthodox seeds that can exist in the dry state for extended periods, include most annual and biennial crops (most cereals and legumes) and many vegetable seeds, for example, lettuce, cabbage and rapeseed (canola).
2. Recalcitrant or unorthodox seeds—short-lived, cannot be dried to MC<20-30% without injury, do not tolerate freezing and, therefore, are not amenable to long-term storage. Ex situ conservation of unorthodox seeds is problematic and, for this reason, plants producing recalcitrant seeds are conserved in the growing form rather than as seeds. Recalcitrant species belong mostly to trees and shrubs; common examples of plants that produce recalcitrant seeds include avocado, cacao, coconut, mango, papaya and walnut. Recalcitrant seeds are generally larger than orthodox seeds; indeed, large seeds often have a high moisture or oil content and are generally recalcitrant in their storage behavior.
3. Intermediate seeds—not conforming fully to either the orthodox or the recalcitrant category, having limited tolerance to drying but are sensitive to freezing temperatures. Examples of intermediate seeds include relatively small-seeded agroforestry species, such as citrus, coffee, guava and cashew.

### E. Seed Handling During Different Stages of Maturity (Storage on the Plant)

Seed quality is greatly influenced by prevailing environmental conditions from the time the seeds reach physiological maturity until harvest, and damage due to weather is often a serious factor at this stage. For example, seeds of certain crops (e.g. soybean and groundnut) can lose their viability and vigor, resulting in reduced germination capacity before harvesting.

Other factors e.g., soil conditions, mineral nutrient deficiencies during plant growth, water stress, high or low temperatures, disease and insect damage may also lead to deterioration in seed quality, with reduced viability and vigor at physiological maturity.

It is, therefore, essential to maintain initial seed quality at the highest attainable level, minimizing damage arising from weather and other factors and adopting good practices:
1. raising a healthy seed crop;
2. harvesting early; and
3. making adequate and timely arrangements for seed drying and threshing.

### F. Harvest to Processing (Storage from Harvesting to Processing)

Since seeds have high moisture content at harvest, seed deterioration can be rapid following harvesting. If the cereal seed moisture content is >13% at the time of harvest, rapid and serious deterioration can occur during the periods of storage involving:
1. Transport from the field to drying and the threshing floor;
2. transport from the threshing floor to the processing plant; and
3. storage at the processing plant.

At MC≥13%, mold can grow and heating may occur. The utmost care is required when handling material with a high moisture content after harvest. If seed is harvested at MC>13%, take steps to preserve seed quality. Note that freshly harvested seed may seem dry overall, but individual seeds with high moisture content can initiate mold growth in spots. Aerate freshly harvested seed—even when the seed appears dry. Prevent mechanical admixture and maintain seed lot identity.

### G. Distribution and Marketing (Storage in Warehouse)

After processing, the seed is placed in different forms of storage to await distribution or marketing. Although the ageing of seeds and the reduction in germination cannot be stopped entirely during storage, they can be controlled by providing good storage conditions.

### H. Factors Affecting Seed Longevity in Storage

The maintenance of seed quality and seed longevity in storage warehouses depends on a range of factors (explained below). In general, low moisture content and low temperature reduce the loss of seed viability, and different combinations of moisture content and temperature can be used to prolong seed viability during storage.

### I. Seed Type

The nature or kind of seed, orthodox, recalcitrant or intermediate, affects seed longevity, as sensitivity to drying and temperature influences the natural storability. While seeds of some crops e.g., onion, soybean and groundnut, are naturally short-lived, others e.g., most cereals and grain legumes, last longer in storage.

### J. Initial Seed Quality

The quality of a seed lot cannot be enhanced by putting it into storage (with the exception of sometimes breaking dormancy in hard seeds that would not have germinated otherwise), since the function of good storage is only to maintain the quality status of the seed lot by preventing a rapid deterioration in quality. The storability of seed depends on its quality at the beginning of storage because seed of high initial quality (germination and vigour) is much more resistant to unfavorable conditions in the storage environment than low quality seed. A seed lot with highly vigorous and undeteriorated seeds stores longer than deteriorated seed lots, because once deterioration begins, the process is rapid. Even a seed lot that has good germination at the beginning of storage can decline rapidly, depending on the severity of damage to its seeds. It is, therefore, important to carry over only high-quality seed for future planting seasons and to reject low quality seed.

### K. Seed Moisture Content

It is essential to dry seeds to a safe moisture content, because the moisture level is probably the most important factor influencing seed viability during storage. In general, if moisture content increases, storage life decreases. High moisture content can lead to mould growth and rapid losses; very low moisture content (MC<4%) can result in extreme desiccation, causing damage to seeds or hard seededness. The safe moisture content depends on:
1. desired length of storage;
2. type of storage structure;
3. seed type; and
4. nature of packaging material used.

For example, under ordinary storage conditions for 12-18 months, drying to MC 10% is sufficient for cereals, while for storage in sealed containers, drying to MC 5-8% may be necessary.

### L. Relative Humidity and Temperature

Relative humidity is the amount of water present in the air at a given temperature in proportion to its maximum water-holding capacity. Seed moisture content changes constantly in relation to the temperature and relative humidity of the air surrounding the seed. Seeds are hygroscopic, readily absorbing and releasing water based on the amount of water surrounding them. Seeds absorb or lose moisture until the vapor pressure of seed moisture and atmospheric moisture reach an equilibrium; at this point the seeds attain a specific and characteristic moisture content: the equilibrium moisture content. At equilibrium moisture content, there is no net gain or loss in seed moisture content.

When seed is placed in a new environment, if the relative humidity is higher or lower than the level at which its moisture content is in equilibrium, the seed will gain or lose moisture until an equilibrium is re-established with the new environment. In sealed storage, seed moisture content determines the relative humidity of the environment in the containers.

Establishment of moisture equilibrium in seeds takes time, it is not instantaneous. The time required to establish moisture equilibrium depends on:
1. seed kind;
2. initial moisture content;
3. average relative humidity; and
4. temperature.

Under open storage conditions, seed moisture content fluctuates with changes in relative humidity. However, normal daily fluctuation in relative humidity has little effect on moisture content. In general, for a particular kind of seed at a given relative humidity, equilibrium moisture content increases as temperature decreases. Therefore, maintenance of seed moisture content during storage is a function of relative humidity and, to a lesser extent, of temperature. Although temperature is not the controlling factor in the maintenance of seed moisture content during storage, it plays an important role in the life of the seed because infestation by insects and development of mould increase as temperature increases. The higher the moisture content of the seeds, the more the seeds are adversely affected by temperature: to maintain seed quality in storage, decrease temperature and reduce seed moisture. Low temperatures are very effective in maintaining seed quality even when relative humidity is high. Good cold storage for seed should not exceed 60% RH. To assess the effect of moisture and temperature on seed storage, follow the guidelines of Harrington:
1. For every decrease of 1% in seed moisture content the life of the seed doubles. (applicable at MC 5-14%)
2. For every decrease of 5° C. in storage temperature the life of the seed doubles. (applicable at temperatures of 0-50° C.)
3. For good seed storage the sum of the RH % in the storage environment and the storage temperature (in ° F.) is 100. (applicable at temperatures≤50° F.)

### M. Factors Contributing to Seed Deterioration

Seed deterioration is the natural process of decline in seed quality over time due to exposure to challenging external factors. Multiple factors contribute to the rate of seed deterioration leading to physical, physiological and biochemical changes in the seeds. These changes reduce the viability of the seed and ultimately cause its death.

Seed deterioration can start as soon as the seed reaches physiological maturity: the seed ceases to receive the full protection of the mother plant and it is exposed to the external environment in terms of moisture, temperature, biotic pressures etc. From physiological maturity through to planting, seed deterioration is affected by a range of factors during different phases:
1. Pre-harvest
2. Harvest and post-harvest
3. Warehouse storage
4. Transport and transit

### N. Pre-Harvest

Seed storage starts in the field and high-quality seed requires optimum preharvest factors. Seed quality (germination capacity, viability, vigor and health) is affected by field location and by field weathering (exposure to adverse conditions, resulting in high relative humidity and high temperature), more specifically:
1. Rainfall after ripening and physiological maturity, exposes the seed to hot and humid pre-harvest conditions, leading to loss in seed quality. Heavy and prolonged rainfall results in increased moisture content, hastened seed respiration and possible fungal activity, causing rapid deterioration of quality.
2. Adverse environmental conditions at seed filling and maturation can result in forced seed maturation, leading to low yields and poor quality.
3. Delayed harvest beyond optimum maturity extends field exposure and intensifies seed deterioration.
4. Location of seed production has a high impact not only on yield, but also on seed moisture management and overall quality (viability, germination capacity, seed vigour and health).

Weathering does not only lower seed germination, but also increases susceptibility to mechanical damage and disease infection. To avoid weathering, ensure timely harvesting to avoid prolonged exposure of the seed to moisture. Rainfree regions with low relative humidity and cool temperatures during seed maturation and harvest are most suited for seed production; regions with high rainfall, high humidity and excessively high temperatures present problems.

### O. Harvest and Post-Harvest

Seed quality depends on the handling methods adopted during harvesting and post-harvest. Deterioration can occur during drying, threshing, processing, collecting, handling and transporting. Indeed, mechanical damage is a major cause of seed deterioration during harvest and post-harvest stages. Very dry seeds are prone to mechanical damage and injury (cracking and bruising), resulting in physical damage or fracturing of essential seed parts. Broken seedcoats permit early entry and easy access for microflora, making the seed vulnerable to fungal attack and reducing its storage potential.

### P. Warehouse Storage

Maintenance of seed quality and seed longevity in storage warehouses depends on the initial seed viability, initial moisture content and the combination of temperature and relative humidity during storage. Management practices adopted during warehouse storage (e.g. regulation of temperature and relative humidity) can only build on the initial seed quality.

Deterioration of seed during storage is inevitable, but the rate of decline depends on the seed's initial quality:
1. Seeds with high initial viability maintain their quality in storage longer than seeds with low initial viability.
2. Vigorous and undamaged seeds can store longer than damaged seeds.
3. Seeds developed under environmental stress conditions (e.g. drought, nutrient deficiency and high temperatures) are more susceptible to rapid deterioration.
4. Seeds that are broken, cracked or bruised due to handling deteriorate more rapidly in storage than undamaged seeds (e.g. cracks create an entrance for pathogens).

Seed heat production accelerates deterioration. Respiration occurs in all living cells (including seeds) and can lead to heat production. Aerobic respiration, occurring in the presence of oxygen, is essentially responsible for the breakdown of carbohydrates, fats and proteins to carbon dioxide, water and energy. The energy liberated during aerobic respiration is used by the cells to fuel metabolic processes and is then released as heat.

### Q. Transport and Transit

Seed is “in storage” during transport and transit, while on the premises of the trader or agro-dealer and also when with the farmer before planting. All measures should be taken to maintain the quality status of the seed at all times through to planting under good soil conditions to support germination and seedling growth. The principles of seed storage regarding handling and management of the storage environment remain the same, whether the seed is in the warehouse or in the premises of the agro-dealer or farmer.

### Anthocyanins

Anthocyanins are bioactive compounds available in a large variety of fruits, vegetables, flowers and other plant tissues, such as, berries, cabbage, blood orange, grape and butterfly pea. The anthocyanins are polyphenols having antioxidant activities, which are responsible for some biological activities and health-promoting properties in preventing or lowering the risk of cardiovascular disease, diabetes, arthritis and cancer. Besides being used as an antioxidant to fortify in food products, anthocyanins are also a predominant choice for natural food colorants providing the bright red-orange to blue-violet. Color is one the most important characteristics of food products to bring a good impression for consumer acceptance.

Anthocyanins are the largest and the most important group of water-soluble pigments in nature with comparatively low toxicity. Clitoria ternatea (butterfly pea) is one of the herbs that are rich in anthocyanins in its petals. It is commonly used as a colorant in Thai beverages and traditional desserts. In addition, many food industries have shifting their interest towards using anthocyanins from natural sources as a food colorant instead of the artificial one. However, the natural food colorants often have stability problem. The stability of anthocyanins depends on a combination of various factors, such as structure and concentration of the anthocyanins, pH, temperature and the presence of complexing agents (i.e., phenols and metals).

### Bixin

Bixin is an apocarotenoid found in the seeds of the Annatto plant (Bixa orellana) from which it derives its name. It is commonly extracted from the seeds to form annatto, a natural food coloring, containing about 5% pigments of which 70-80% are bixin.

Annatto is a shrub native to the South American tropics, the natural reddish-yellow color of which is obtained from the outer coating of its seeds. The major pigments present are carotenoids, including a large amount of cis-bixin and other minor constituents, such as trans-bixin, cis-norbixin and trans-norbixin. Annatto is almost unique among the sources of carotenoids, as its pigment takes on a number of different chemical structures; the range of intense colors its compounds take include shades of red, orange and yellow. Annatto can be obtained from hydrophilic and hydrophobic extracts, and its pigments are very stable due to their interactions with protein compounds. Thus, it is an excellent candidate for a natural pigment to be used in cosmetics, pharmaceuticals and the food industry.

### EXAMPLES

### Example 1: Dried Petal Preservation Using an Oxygen Scavenging Agent

The Objective: Evaluate the effects of oxygen absorber packet (OxySorb®) in prolonging the shelf life of BFP petals. Treatments with OxySorb® packets with a dose of 300 cc will be part of the experiment. The temporal treatments will be divided in three terms; 4, 8 and 12 months with a 2 replicate on each experiment. The list of items needed to execute the experiments are PE vacuum bags (5 Kg size), OxySorb® packets (300 cc) and dried BFP petals with aging of 1 to 2 weeks (≤10% moisture content).

Methodology: The experiment considers the mix 10-20 kg of dried BFP petals from the same lot, weigh 5 kg each of BFP petals and place them on individual PE bags. Note: If mixing 10 kg petals, one 5 kg bag will have one 300 cc OxySorb® packet. The other 5 kg bag will have none, this will be the negative control. Alternative: If mixing 20 kg petals, 2 bags will have one 300 cc OxySorb® packet each and the other two bags will have no OxySorb® packet. The procedure will repeat until we have two full set of data each, 5 kg bags for the with and without OxySorb® packets. For the corresponding temporal treatments 4, 8 and 12 months will be the time frame. For the labeling of the samples we present this example (With OxySorb®—4 months—Rep1) There will be a total of 12 bags divided as (2 reps×2 OxySorb® treatments×3 temporal treatments=12 bags). Preparation of a 5 kg of BFP petals from the same lot in unsealed bag without OxySorb® packet as untreated control. Note: A total of 65 kg of dried BFP petals will be needed for the experiment. The samples will be kept in cardboard boxes until all be shipped, except for the unsealed control which will just be placed next to the boxes.

Collection of the data will be by photos of the bags in treatment pairs by replication at the start of the experiment. Example of the labeling with OxySorb®—Time frame 4 months—Rep1 and without OxySorb®—Time frame 4 months—Rep1. After each of the temporal treatments a photo of the bags will be use as documentations of the procedure. After the photo open up the 4 months treatment bags, take a small amount of samples petal and take photos of it. Document any color changes or presence of molds or bacteria on each sample. Take 9 petals from each treatment bag per replicate put them in a clear glass with hot water. After 10 minutes, take a picture of each glass per treatment per replicate. A spectrophotometer was used to measure the color strength of each sample. Send samples to a Microbiology lab to test for microbial activity. Repeat all steps for the 8- and 12-months temporal treatments.

### Example 2: Seed Preservation Using an Oxygen Scavenging Agent

The objective is to evaluate the effects of oxygen absorber packet (OxySorb®) in prolonging seed storage life and viability. Treatments with OxySorb® packets with a dose of 100 cc will be part of the experiment. The temporal treatments will be divided in three terms; 6, 12 and 18 months with a 3 replicate on each experiment. The list of items needed to execute the experiments are PE vacuum bags (500 g size), OxySorb® packets (100 cc), BFP seeds with an aging of 1 to 2 weeks (≤10% moisture content) and annatto seeds with an aging of 1 to 2 weeks (≤10% moisture content).

The methodology for the experiment considers the mix 4-4 kg of dried BFP seeds from the same lot, preferably harvested from the same plot or trees. Weigh 100 g of seeds and place them on individual PE bags. Add 100 cc OxySorb® packet per storage temporal treatments and the negative control treatment pair will no have OxySorb® packet. Repeat the same process, until we have three replicates each of 100 g bags for the with or without OxySorb® packets for 6, 12, and 18 months. For the labeling of the samples we present this example, e.g., With OxySorb®—6 months—Rep1. There will be a total of 18 bags divided as (3 reps×2 OxySorb® treatments×3 temporal treatments=18 bags). Preparation of 100 g of seeds from the same lot in unsealed bag, without OxySorb® packet as untreated control. Note: A total of 1.9 kg of seeds will be needed for the experiment. For storage, keep all the bags under room temperature.

Collection of the data after 6 months, run a paper towel germination assay using 20 seeds each from each rep from the 6 months bags.

### Paper Towel Germination Assay

1. Materials: permanent marker, Ziplock bags, paper towel
2. Label each Ziplock bag with the treatment and rep
3. Moisten the paper towel with clean water thoroughly but not dripping
4. Spread the damp paper towel out on a clean, flat surface. Place your seeds, evenly spaced without overcrowding, on one half of the paper towel.
5. Carefully fold the empty half of the paper towel over the seeds. Place the folded paper towel into the appropriately labeled Ziploc bag, and seal the bag. Repeat with the remaining seeds.
6. Place the zipper bags of seeds in a warm place away from direct sunlight.
7. Check on the seeds every other day. Open the zipper bag to allow fresh air to enter and check to see if your seeds have sprouted.
8. Record the final percent germination after 14 days.

Document of the germinated seeds per treatment, repeat the all steps for the 12- and 18-months temporal treatments are shown in Tables 1 and Tables 2.

TABLE 1
Germination Testing

| | | | Date | | | | |
|---|---|---|---|---|---|---|---|
| | Date | | Germ | Germination rating | | | Germ |
| Crop | packaged | Type Package | Tested | REP 1 | REP 2 | REP 3 | average |
| Annatto | Jul. 10, 2020 | NONE | Jul. 13, 2020 | 13:15 | 13:15 | 13:15 | 86.60% |
| Annatto | | Zip lock | Oct. 13, 2020 | | | | |
| Annatto | | Mylar | Oct. 13, 2020 | | | | |
| Annatto | | Mylar + | Oct. 13, 2020 | | | | |
| | | OxySorb | | | | | |
| Annatto | | Zip lock | Jan. 13, 2021 | | | | |
| Annatto | | Mylar | Jan. 13, 2021 | | | | |
| Annatto | | Mylar + | Jan. 13, 2021 | | | | |
| | | OxySorb | | | | | |
| Annatto | | Zip lock | Apr. 13, 2021 | | | | |
| Annatto | | Mylar | Apr. 13, 2021 | | | | |
| Annatto | | Mylar + | Apr. 13, 2021 | | | | |
| | | OxySorb | | | | | |
| Annatto | | Zip lock | Jul. 13, 2021 | | | | |
| Annatto | | Mylar | Jul. 13, 2021 | | | | |
| Annatto | | Mylar + | Jul. 13, 2021 | | | | |
| | | OxySorb | | | | | |
| Annatto | | Zip lock | Oct. 13, 2021 | | | | |
| Annatto | | Mylar | Oct. 13, 2021 | | | | |
| Annatto | | Mylar + | Oct. 13, 2021 | | | | |
| | | OxySorb | | | | | |
| Annatto | | Zip lock | Jan. 13, 2022 | | | | |
| Annatto | | Mylar | Jan. 13, 2022 | | | | |
| Annatto | | Mylar + | Jan. 13, 2022 | | | | |
| | | OxySorb | | | | | |
| Corn | Jul. 10, 2020 | NONE | Jul. 13, 2020 | 15:15 | 15:15 | 14:15 | 97.80% |
| Corn | | Zip lock | Oct. 13, 2020 | | | | |
| Corn | | Mylar | Oct. 13, 2020 | | | | |
| Corn | | Mylar + | Oct. 13, 2020 | | | | |
| | | OxySorb | | | | | |
| Corn | | Zip lock | Jan. 13, 2021 | | | | |
| Corn | | Mylar | Jan. 13, 2021 | | | | |
| Corn | | Mylar + | Jan. 13, 2021 | | | | |
| | | OxySorb | | | | | |
| Corn | | Zip lock | Apr. 13, 2021 | | | | |
| Corn | | Mylar | Apr. 13, 2021 | | | | |
| Corn | | Mylar + | Apr. 13, 2021 | | | | |
| | | OxySorb | | | | | |
| Corn | | Zip lock | Jul. 13, 2021 | | | | |
| Corn | | Mylar | Jul. 13, 2021 | | | | |
| Corn | | Mylar + | Jul. 13, 2021 | | | | |
| | | OxySorb | | | | | |
| Corn | | Zip lock | Oct. 13, 2021 | | | | |
| Corn | | Mylar | Oct. 13, 2021 | | | | |
| Corn | | Mylar + | Oct. 13, 2021 | | | | |
| | | OxySorb | | | | | |
| Corn | | Zip lock | Jan. 13, 2022 | | | | |
| Corn | | Mylar | Jan. 13, 2022 | | | | |
| Corn | | Mylar + | Jan. 13, 2022 | | | | |
| | | OxySorb | | | | | |
| Safflower | Jul. 10, 2020 | NONE | Jul. 13, 2020 | 12:15 | 11:15 | 12:15 | 77.80% |
| Safflower | | Zip lock | Oct. 13, 2020 | | | | |
| Safflower | | Mylar | Oct. 13, 2020 | | | | |
| Safflower | | Mylar + | Oct. 13, 2020 | | | | |
| | | OxySorb | | | | | |
| Safflower | | Zip lock | Jan. 13, 2021 | | | | |
| Safflower | | Mylar | Jan. 13, 2021 | | | | |
| Safflower | | Mylar + | Jan. 13, 2021 | | | | |
| | | OxySorb | | | | | |
| Safflower | | Zip lock | Apr. 13, 2021 | | | | |
| Safflower | | Mylar | Apr. 13, 2021 | | | | |
| Safflower | | Mylar + | Apr. 13, 2021 | | | | |
| | | OxySorb | | | | | |
| Safflower | | Zip lock | Jul. 13, 2021 | | | | |
| Safflower | | Mylar | Jul. 13, 2021 | | | | |
| Safflower | | Mylar + | Jul. 13, 2021 | | | | |
| | | OxySorb | | | | | |
| Safflower | | Zip lock | Oct. 13, 2021 | | | | |
| Safflower | | Mylar | Oct. 13, 2021 | | | | |
| Safflower | | Mylar + | Oct. 13, 2021 | | | | |
| | | OxySorb | | | | | |
| Safflower | | Zip lock | Jan. 13, 2022 | | | | |
| Safflower | | Mylar | Jan. 13, 2022 | | | | |
| Safflower | | Mylar + | Jan. 13, 2022 | | | | |
| | | OxySorb | | | | | |
| Soybean | Jul. 10, 2020 | NONE | Jul. 13, 2020 | 14:15 | 14:15 | 15:15 | 95.60% |
| Soybean | | Zip lock | Oct. 13, 2020 | | | | |
| Soybean | | Mylar | Oct. 13, 2020 | | | | |
| Soybean | | Mylar + | Oct. 13, 2020 | | | | |
| | | OxySorb | | | | | |
| Soybean | | Zip lock | Jan. 13, 2021 | | | | |
| Soybean | | Mylar | Jan. 13, 2021 | | | | |
| Soybean | | Mylar + | Jan. 13, 2021 | | | | |
| | | OxySorb | | | | | |
| Soybean | | Zip lock | Apr. 13, 2021 | | | | |
| Soybean | | Mylar | Apr. 13, 2021 | | | | |
| Soybean | | Mylar + | Apr. 13, 2021 | | | | |
| | | OxySorb | | | | | |
| Soybean | | Zip lock | Jul. 13, 2021 | | | | |
| Soybean | | Mylar | Jul. 13, 2021 | | | | |
| Soybean | | Mylar + | Jul. 13, 2021 | | | | |
| | | OxySorb | | | | | |
| Soybean | | Zip lock | Oct. 13, 2021 | | | | |
| Soybean | | Mylar | Oct. 13, 2021 | | | | |
| Soybean | | Mylar + | Oct. 13, 2021 | | | | |
| | | OxySorb | | | | | |
| Soybean | | Zip lock | Jan. 13, 2022 | | | | |
| Soybean | | Mylar | Jan. 13, 2022 | | | | |
| Soybean | | Mylar + | Jan. 13, 2022 | | | | |
| | | OxySorb | | | | | |
| Wheat | Jul. 10, 2020 | NONE | Jul. 13, 2020 | 24:25 | 25:25 | 25:25 | 98.70% |
| Wheat | | Zip lock | Oct. 13, 2020 | | | | |
| Wheat | | Mylar | Oct. 13, 2020 | | | | |
| Wheat | | Mylar + | Oct. 13, 2020 | | | | |
| | | OxySorb | | | | | |
| Wheat | | Zip lock | Jan. 13, 2021 | | | | |
| Wheat | | Mylar | Jan. 13, 2021 | | | | |
| Wheat | | Mylar + | Jan. 13, 2021 | | | | |
| | | OxySorb | | | | | |
| Wheat | | Zip lock | Apr. 13, 2021 | | | | |
| Wheat | | Mylar | Apr. 13, 2021 | | | | |
| Wheat | | Mylar + | Apr. 13, 2021 | | | | |
| | | OxySorb | | | | | |
| Wheat | | Zip lock | Jul. 13, 2021 | | | | |
| Wheat | | Mylar | Jul. 13, 2021 | | | | |
| Wheat | | Mylar + | Jul. 13, 2021 | | | | |
| | | OxySorb | | | | | |
| Wheat | | Zip lock | Oct. 13, 2021 | | | | |
| Wheat | | Mylar | Oct. 13, 2021 | | | | |
| Wheat | | Mylar + | Oct. 13, 2021 | | | | |
| | | OxySorb | | | | | |
| Wheat | | Zip lock | Jan. 13, 2022 | | | | |
| Wheat | | Mylar | Jan. 13, 2022 | | | | |
| Wheat | | Mylar + | Jan. 13, 2022 | | | | |
| | | OxySorb | | | | | |
| Sunflower | | NONE | Jul. 13, 2020 | | | | |
| Sunflower | | Zip lock | Oct. 13, 2020 | | | | |
| Sunflower | | Mylar | Oct. 13, 2020 | | | | |
| Sunflower | | Mylar + | Oct. 13, 2020 | | | | |
| | | OxySorb | | | | | |
| Sunflower | | Zip lock | Jan. 13, 2021 | | | | |
| Sunflower | | Mylar | Jan. 13, 2021 | | | | |
| Sunflower | | Mylar + | Jan. 13, 2021 | | | | |
| | | OxySorb | | | | | |
| Sunflower | | Zip lock | Apr. 13, 2021 | | | | |
| Sunflower | | Mylar | Apr. 13, 2021 | | | | |
| Sunflower | | Mylar + | Apr. 13, 2021 | | | | |
| | | OxySorb | | | | | |
| Sunflower | | Zip lock | Jul. 13, 2021 | | | | |
| Sunflower | | Mylar | Jul. 13, 2021 | | | | |
| Sunflower | | Mylar + | Jul. 13, 2021 | | | | |
| | | OxySorb | | | | | |
| Sunflower | | Zip lock | Oct. 13, 2021 | | | | |
| Sunflower | | Mylar | Oct. 13, 2021 | | | | |
| Sunflower | | Mylar + | Oct. 13, 2021 | | | | |
| | | OxySorb | | | | | |
| Sunflower | | Zip lock | Jan. 13, 2022 | | | | |
| Sunflower | | Mylar | Jan. 13, 2022 | | | | |
| Sunflower | | Mylar + | Jan. 13, 2022 | | | | |
| | | OxySorb | | | | | |
| Canola | | NONE | Jul. 13, 2020 | | | | |
| Canola | | Zip lock | Oct. 13, 2020 | | | | |
| Canola | | Mylar | Oct. 13, 2020 | | | | |
| Canola | | Mylar + | Oct. 13, 2020 | | | | |
| | | OxySorb | | | | | |
| Canola | | Zip lock | Jan. 13, 2021 | | | | |
| Canola | | Mylar | Jan. 13, 2021 | | | | |
| Canola | | Mylar + | Jan. 13, 2021 | | | | |
| | | OxySorb | | | | | |
| Canola | | Zip lock | Apr. 13, 2021 | | | | |
| Canola | | Mylar | Apr. 13, 2021 | | | | |
| Canola | | Mylar + | Apr. 13, 2021 | | | | |
| | | OxySorb | | | | | |
| Canola | | Zip lock | Jul. 13, 2021 | | | | |
| Canola | | Mylar | Jul. 13, 2021 | | | | |
| Canola | | Mylar + | Jul. 13, 2021 | | | | |
| | | OxySorb | | | | | |
| Canola | | Zip lock | Oct. 13, 2021 | | | | |
| Canola | | Mylar | Oct. 13, 2021 | | | | |
| Canola | | Mylar + | Oct. 13, 2021 | | | | |
| | | OxySorb | | | | | |
| Canola | | Zip lock | Jan. 13, 2022 | | | | |
| Canola | | Mylar | Jan. 13, 2022 | | | | |
| Canola | | Mylar + | Jan. 13, 2022 | | | | |
| | | OxySorb | | | | | |
| Cotton | Jul. 10, 2020 | NONE | Jul. 13, 2020 | 7:10 | 7:10 | 7:10 | 70% |
| Cotton | | Zip lock | Oct. 13, 2020 | | | | |
| Cotton | | Mylar | Oct. 13, 2020 | | | | |
| Cotton | | Mylar + | Oct. 13, 2020 | | | | |
| | | OxySorb | | | | | |
| Cotton | | Zip lock | Jan. 13, 2021 | | | | |
| Cotton | | Mylar | Jan. 13, 2021 | | | | |
| Cotton | | Mylar + | Jan. 13, 2021 | | | | |
| | | OxySorb | | | | | |
| Cotton | | Zip lock | Apr. 13, 2021 | | | | |
| Cotton | | Mylar | Apr. 13, 2021 | | | | |
| Cotton | | Mylar + | Apr. 13, 2021 | | | | |
| | | OxySorb | | | | | |
| Cotton | | Zip lock | Jul. 13, 2021 | | | | |
| Cotton | | Mylar | Jul. 13, 2021 | | | | |
| Cotton | | Mylar + | Jul. 13, 2021 | | | | |
| | | OxySorb | | | | | |
| Cotton | | Zip lock | Oct. 13, 2021 | | | | |
| Cotton | | Mylar | Oct. 13, 2021 | | | | |
| Cotton | | Mylar + | Oct. 13, 2021 | | | | |
| | | OxySorb | | | | | |
| Cotton | | Zip lock | Jan. 13, 2022 | | | | |
| Cotton | | Mylar | Jan. 13, 2022 | | | | |
| Cotton | | Mylar + | Jan. 13, 2022 | | | | |
| | | OxySorb | | | | | |

TABLE 2
Seed Germination Testing

| | | | | Germination rating | | | |
|---|---|---|---|---|---|---|---|
| | Date | Type | Date Germ | REP 1 | REP 2 | REP 3 | Germ |
| Crop | packaged | Package | Tested | good:total | good:total | good:total | average |
| Corn | Jul. 10, 2020 | NONE | Jul. 13, 2020 | 15:15 | 15:15 | 14:15 | 97.80% |
| Corn | | Zip lock | Nov. 11, 2020 | 18:20 | 18:20 | 17:20 | 88.30% |
| Corn | | Mylar | Nov. 11, 2020 | 18:20 | 19:20 | 18:20 | 91.60% |
| Corn | | Mylar + | Nov. 11, 2020 | 18:20 | 19:20 | 17:20 | 90.00% |
| | | OxySorb | | | | | |
| Corn | | Zip lock | Mar. 19, 2021 | 13:20 | 11:20 | 14:20 | 63.30% |
| Corn | | Mylar | Mar. 19, 2021 | 14:20 | 14:20 | 14:20 | 70.00% |
| Corn | | Mylar + | Mar. 19, 2021 | 10:20 | 11:20 | 12:20 | 55.00% |
| | | OxySorb | | | | | |
| Corn | | Zip lock | Jun. 8, 2021 | 15:20 | 14:20 | 15:20 | 73.33% |
| Corn | | Mylar | Jun. 8, 2021 | 17:20 | 15:20 | 17:20 | 81.66% |
| Corn | | Mylar + | Jun. 8, 2021 | 11:20 | 13:20 | 9:20 | 55.00% |
| | | OxySorb | | | | | |
| Safflower | Jul. 10, 2020 | NONE | Jul. 13, 2020 | 12:15 | 11:15 | 12:15 | 77.80% |
| Safflower | | Zip lock | Nov. 11, 2020 | 13:20 | 14:20 | 16:20 | 71.60% |
| Safflower | | Mylar | Nov. 11, 2020 | 15:20 | 15:20 | 13:20 | 71.60% |
| Safflower | | Mylar + | Nov. 11, 2020 | 14:20 | 16:20 | 16:20 | 73.33% |
| | | OxySorb | | | | | |
| Safflower | | Zip lock | Mar. 19, 2021 | 14:20 | 14:20 | 14:20 | 70.00% |
| Safflower | | Mylar | Mar. 19, 2021 | 14:20 | 15:20 | 14:20 | 71.60% |
| Safflower | | Mylar + | Mar. 19, 2021 | 15:20 | 13:20 | 16:20 | 75.00% |
| | | OxySorb | | | | | |
| Safflower | | Zip lock | Jun. 8, 2021 | 8:20 | 7:20 | 10:20 | 41.60% |
| Safflower | | Mylar | Jun. 8, 2021 | 13:20 | 13:20 | 14:20 | 66.66% |
| Safflower | | Mylar + | Jun. 8, 2021 | 12:20 | 13:20 | 13:20 | 63.33% |
| | | OxySorb | | | | | |
| Soybean | Jul. 10, 2020 | NONE | Jul. 13, 2020 | 14:15 | 14:15 | 15:15 | 95.60% |
| Soybean | | Zip lock | Nov. 11, 2020 | 18:20 | 18:20 | 18:20 | 90.00% |
| Soybean | | Mylar | Nov. 11, 2020 | 17:20 | 20:20 | 19:20 | 93.30% |
| Soybean | | Mylar + | Nov. 11, 2020 | 19:20 | 18:20 | 19:20 | 93.30% |
| | | OxySorb | | | | | |
| Soybean | | Zip lock | Mar. 19, 2021 | 16:20 | 16:20 | 16:20 | 80.00% |
| Soybean | | Mylar | Mar. 19, 2021 | 18:20 | 17:20 | 18:20 | 88.33% |
| Soybean | | Mylar + | Mar. 19, 2021 | 17:20 | 15:20 | 17:20 | 81.60% |
| | | OxySorb | | | | | |
| Soybean | | Zip lock | Jun. 8, 2021 | 16:20 | 18:20 | 16:20 | 83.33% |
| Soybean | | Mylar | Jun. 8, 2021 | 16:20 | 17:20 | 18:20 | 85.00% |
| Soybean | | Mylar + | Jun. 8, 2021 | 18:20 | 18:20 | 17:20 | 88.30% |
| | | OxySorb | | | | | |
| Wheat | Jul. 10, 2020 | NONE | Jul. 13, 2020 | 24:25 | 25:25 | 25:25 | 98.70% |
| Wheat | | Zip lock | Nov. 11, 2020 | 96:100 | 96:100 | 97:100 | 96.30% |
| Wheat | | Mylar | Nov. 11, 2020 | 97:100 | 98:100 | 99:100 | 98.00% |
| Wheat | | Mylar + | Nov. 11, 2020 | 98:100 | 97:100 | 100:100 | 98.30% |
| | | OxySorb | | | | | |
| Wheat | | Zip lock | Mar. 19, 2021 | 95:100 | 96:100 | 95:100 | 95.30% |
| Wheat | | Mylar | Mar. 19, 2021 | 99:100 | 98:100 | 98:100 | 98.30% |
| Wheat | | Mylar + | Mar. 19, 2021 | 97:100 | 100:100 | 97:100 | 98.00% |
| | | OxySorb | | | | | |
| Wheat | | Zip lock | Jul. 13, 20201 | 94:100 | 95:100 | 96:100 | 95.00% |
| Wheat | | Mylar | Jul. 13, 20201 | 98:100 | 97:100 | 98:100 | 97.66% |
| Wheat | | Mylar + | Jul. 13, 20201 | 98:100 | 97:100 | 98:100 | 97.66% |
| | | OxySorb | | | | | |
| Canola | | NONE | Jul. 13, 2020 | 81:100 | 83:100 | 83:100 | 82.30% |
| Canola | | Zip lock | Nov. 11, 2020 | 72:100 | 71:100 | 72:100 | 71.60% |
| Canola | | Mylar | Nov. 11, 2020 | 75:100 | 77:100 | 77:100 | 76.30% |
| Canola | | Mylar + | Nov. 11, 2020 | 69:100 | 77:100 | 79:100 | 75.00% |
| | | OxySorb | | | | | |
| Canola | | Zip lock | Jun. 8, 2021 | 55:100 | 51:100 | 48:100 | 51.33% |
| Canola | | Mylar | Jun. 8, 2021 | 58:100 | 61:100 | 53:100 | 57.33% |
| Canola | | Mylar + | Jun. 8, 2021 | 68:100 | 72:100 | 67:100 | 69.00% |
| | | OxySorb | | | | | |
| Cotton | Jul. 10, 2020 | NONE | Jul. 13, 2020 | 6:10 | 6:10 | 5:10 | 56.60% |
| Cotton | | Zip lock | Nov. 11, 2020 | 9:20 | 9:20 | 9:20 | 45.00% |
| Cotton | | Mylar | Nov. 11, 2020 | 10:20 | 11:20 | 10:20 | 51.60% |
| Cotton | | Mylar + | Nov. 11, 2020 | 10:20 | 9:20 | 9:20 | 46.60% |
| | | OxySorb | | | | | |

1. A method to preserve a plant pigment from a part of a harvested plant comprising: a harvested plant part housed in container, wherein the container has a low oxygen environment, wherein low oxygen environment is a result of at least one oxygen-scavenging agent.

2. The method of claim 1, wherein said low oxygen environment further comprises a nitrogen gas-flushed environment.

3. The method of claim 1, wherein the part of a harvested plant is a seed.

4. The method of claim 3, wherein the seed is from an Annatto plant.

5. The method of claim 4, wherein the seed comprises an apocarotenoid, wherein the apocarotenoid is bixin.

6. The method of claim 1, wherein the part of the harvest plant is a flower.

7. The method of claim 6, wherein the flower is from Clitoria ternatea (butterfly pea).

8. The method of claim 7, wherein the flower comprises an anthocyanin pigment.

9. A method to increase seed viability comprising: placing a seed or a population of seeds in container having a low oxygen environment, wherein said low oxygen environment further comprises at least one oxygen-scavenging agent.
